(19) United States
(12) Patent Application Publication
(10) Pub. No.: US 2006/0168553 A1
(43) Pub. Date: Jul. 27, 2006

(54) Software development kit for real-time communication applications and system

(75) Inventor: Allen E Drennan, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: WIREDRED SOFTWARE CORPORATION, San Diego, CA (US)

(21) Appl. No.: 10/523,192

(22) PCT Filed: Jul. 25, 2003
(86) PCT No.: PCT/US03/23331

§ 371 Date: Dec. 2, 2005

Related U.S. Application Data
(60) Provisional application No. 60/398,940, filed on Jul. 25, 2002.

(51) Int. Cl. G06F 9/44

(52) U.S. Cl. 717/100

(57) ABSTRACT

A software development kit enables developers to provide real-time communications capabilities to existing software applications.

### CROSS-REFERENCE TO RELATED APPLICATIONS

The present application claims the benefit of U.S. Provisional Application Ser. No. 60/398,940, filed Jul. 25, 2002, titled Software Development Kit for Real-Time Communication Application and System.

### FIELD OF THE INVENTION

The present invention relates to a real-time software development kit (SDK) and, more particularly, a real-time software development kit that is utilized in secure instant messaging and enterprise real-time communications software.

### BACKGROUND OF THE INVENTION

The consumer instant messaging (IM) model, which is well known in consumer environments such as America Online, and the like, does not generally suit the needs of businesses. Businesses typically handle many aspects of instant communications differently than the consumer instant messaging user. In most cases, business users do not want add or subscribe colleagues to “buddy” lists. Instead, business users want to see their co-workers automatically in a comprehensive, yet well organized list of objects. Grouping is left to the end-user client on an ad hoc in most consumer IM applications. In the business world, there is a need for groupings that follow the sophisticated tree structures of business organizations. Typical consumer IM solutions do not provide the level of control required by most enterprises, nor do they offer sufficient security controls or centralized management of groups and profile lists.

There has recently been developed a real-time routing architecture provides the underlying technology building blocks for business instant messaging and enterprise real-time communication software. Servers and clients utilize real-time routing architecture that provides a secure, two-way, real-time communications platform that may be used to build a variety of high performance custom applications. Key components in the platform include the real-time engine featuring intelligent routing, user identification and presence, or status, virtual channels and pipes. Pipes support a variety of multi-server topologies, providing massive scalability and/or multi-office communications. The scalable presence management system is capable of managing and displaying real-time status of thousands of users, known as presence objects, without creating network bottlenecks with status updates.

### SUMMARY OF THE INVENTION

Disclosed is a new instant messaging and enterprise real-time communication software, referred to herein as a real-time software development kit (SDK). The SDK of the present invention provides a set of application programming interfaces (APIs) that enables developers and business partners, including system integrators, ISVs, OEMs, hardware appliance manufacturers and ASPs, to create custom client/server and web-based instant messaging (IM) applications based on the real-time routing architecture disclosed herein, which provides a secure, two-way real-time communications platform. The SDK disclosed herein meets the needs of organizations that have a desire to rapidly develop secure IM applications, with the capability of scaling-up in complex enterprise network environments.

The SDK supports Microsoft Visual Studio and Delphi development toolsets, with certified languages including Visual Basic NET, Visual C#, and Delphi. The SDK includes COM and ActiveX Objects and Delphi native components, sample applications with source code, online documentation and development environment set-up.

The SDK of the present invention provides a fully functional, secure instant messaging client with an easy to use interface, with a one-way secure instant messaging application for emergency notifications and other broadcast applications, and a web-based IM interface. These can be readily adapted to internal and customer-facing applications such as CRM, ERP, Enterprise Information Portals (EIP), web front-ends, line-of-business and legacy applications.

The enterprise server as disclosed herein provides the server component for the SDK Run-Time Client. The server delivers authentication, security, directory service integration, groups, profiles and other central management capabilities to custom client applications. The server supports multi-server topologies, multi-threading and symmetric multi-processing (SMP), enabling secure IM applications for thousands or tens-of-thousands of users. In addition, it provides private routing over LAN, WANs, VPNs, NATs, proxies and firewalls. This “private routing” as disclosed herein provides the capability that supports the complex, distributed network environments found in most large organizations today.

The SDK of the present invention extends the real-time routing architecture. The SDK provides an extensible, open interface for bidirectional messaging, which supports any real-time data communications stream and any data type. The SDK of the present invention allows third-party developers to define their own data types.

Enterprise instant messaging is evolving into a viable business productivity tool for companies of all sizes. The core components of presence management, secure instant messaging and text chat provide developers utilizing the disclosed invention the ability to create custom instant messaging applications. The ability to add real-time presence to existing applications is a powerful enhancement.

### BRIEF DESCRIPTION OF THE DRAWINGS

FIG. 1 is a block diagram a physical network of clients and servers according to the present invention.

FIG. 2 is a block diagram of a real-time routing architecture according to the present invention.

### DETAILED DESCRIPTION OF THE PREFERRED EMBODIMENTS

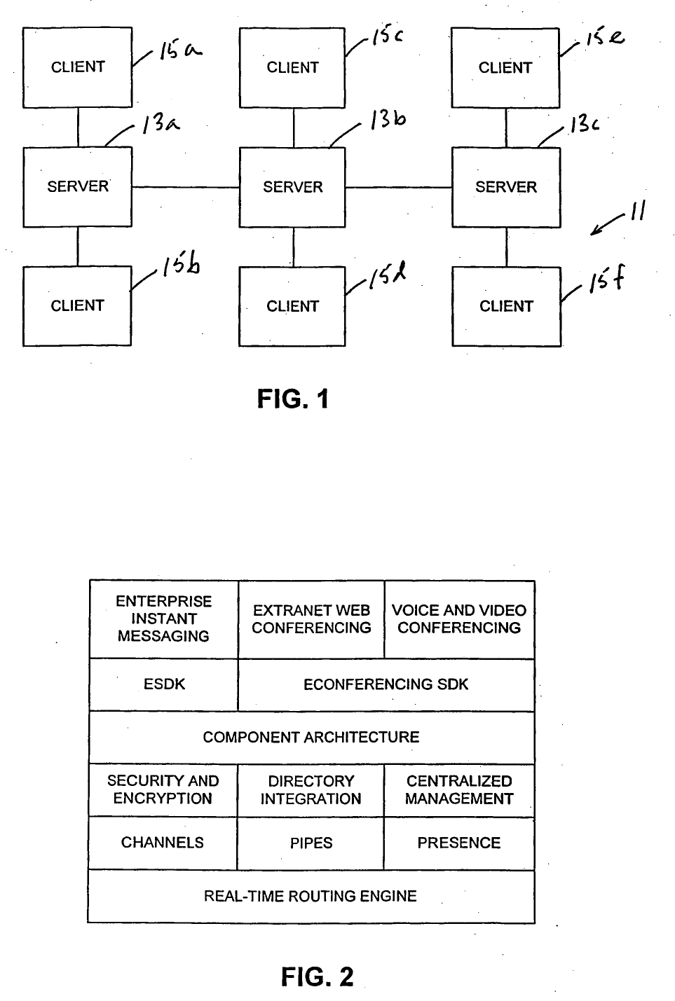

Referring now to the drawings, and first to FIG. 1, a network is designated generally by the numeral 11. Network 11 includes interconnected real-time routing servers 13, which provide a real-time routing engine, and clients 15. According to the present invention, servers 13 are connected to each other by virtual pipes. The pipes route, secure and compress data between sub-networks. The pipes provide the custom-routing necessary to support communications over virtually any TCP/IP connection, as well as VPNs, gateways and firewalls. Users, through clients 15, are connected to real-time routing servers 13 by connections. The connections may be through LANs, WANs, the Internet, RAS, Dial-up networking, VPNs, Citrix Winframe/Metaframe and Windows Terminal Services through gateways, proxies and firewalls. Once connected, users immediately appear as real-time presence objects in the real-time routing system. Servers 13 track users by the location of their status or presence. Servers 13 can relearn routes to users throughout the system in the event of physical routing failure. Network 11 may be of any topology, such as ring, star, mesh or the like.

To establish communications between distributed users across various connections, the real-time routing system establishes virtual channels between various users. Users are joined to a channel through the use of a real-time join. All subsequent communications directed toward the channel are directed to all joined users on the channel. The channel mechanism is efficiently designed to ensure that data is not transmitted more than once across any pipe when directed to a channel.

The logical structure of a system according to the present invention is illustrated in FIG. 2. The real-time routing engine comprises channels, pipes and presence, described with reference to FIG. 1. Additionally, the real-time routing engine comprises security and encryption, directory integration and centralized management layered above the channels, pipes and presence. The real-time routing engine provides a flexible, secure, manageable, proxy and firewall-friendly real-time routing core.

The security system is designed to support a rich variety of corporate security policies, by providing end-to-end encryption of all message traffic. The real-time engine uses a combination of security protocols. RC4 may be used as a default. However, in addition to RC4, the real-time engine may use DES, triple-DES (128 bits), AES (256 bits) and RSA (up to 512 bits). Additionally, RSA signing, certificates and authentication may be available. These protocols provide a wide variety of key-length, performance trade-offs and corporate security options.

Layered under the security streaming is a compression layer. The compression layer uses a compression format, such as zlib compression described in RFC 1950-1952, on pipes and connections, which achieves up to 4:1 compression. As will be recognized by those skilled in the art, other compression formats may by utilized.

The low-level design code at the server level preferably takes advantage of symmetrical multi-processing (SMP). Each virtual user runs on a separate thread, and when available, these threads are distributed across multiple CPUs within a server. SMP can be useful in the case of large population security alert users. In such a scenario, it is more economical support a large population on one or several servers when there is little traffic. However, when an urgent message is distributed, SMP provides a tremendous performance boost, distributing hundreds of messages per second, per CPU.

Layered above the real-time routing engine is the component architecture, which comprises the ESDK and the EConferencing SDK, which will be described in detail hereinafter. The ESDK and EConferencing SDK enable enterprise instant messaging, extranet web conferencing, and voice and video conferencing.

The ESDK provides a rich set of tools for creating comprehensive real-time communications applications such as instant messaging, chat and presence programs. It is designed to operate in most newer development environments such as those created by Borland and Microsoft. The ESDK is adapted to provide a presence object. The properties, methods and events of the ESDK of the present invention art disclosed as follows.

Properties

PublicKey

{PublicKey”}{xe “TESDK:PublicKey”}

PublicKey: String;

The PublicKey holds the current public key of the client user. The PublicKey is used in conjunction with the PrivateKey for real-time servers that require public key encryption for encrypted communications. The server console can enable this behavior on a real-time server. Under normal circumstances, the PublicKey and PrivateKey are automatically created when they are required for encrypted communications.

The process of creating a PublicKey and PrivateKey can be time consuming. Subsequent client sessions can reuse the PublicKey and PrivateKey from a prior session and avoid the time required to create a new key pair. In the event that the PublicKey and PrivateKey are required for a client session the OnClientCertificateKeys event will be triggered.

Private Key

{xe “PrivateKey”}{xe “TESDK:PrivateKey”}

PrivateKey: String;

The PrivateKey holds the current private key of the client user. The PrivateKey is used in conjunction with the PublicKey for real-time servers that require public key encryption for encrypted communications. The server console can enable this behavior on a real-time server. Under normal circumstances, the PublicKey and PrivateKey are automatically created when they are required for encrypted communications.

MessageAutoClear

{xe “MessageAutoClear”}{xe “TESDK:MessageAutoClear”}

MessageAutoClear: Boolean;

The MessageAutoClear property determines how messages are retained and handled in memory. By default, MessageAutoClear is set to TRUE and messages are not retained in memory once they are sent and messages are not retained in memory once they are received. When sending a message using the SetMessage method, the message information will be cleared from memory when MessageAutoClear is TRUE. Otherwise use the ClearMessage and ClearMessageAll events to clear all messages from memory.

When receiving a message, all message information must be extracted by the client during the OnMessage event using the various GetMessage related methods if MessageAutoClear is TRUE. Once the OnMessage event is finished, the resulting message is deleted from memory if MessageAutoClear is TRUE.

MessageCompressThreshold

{“MessageCompressThreshold”}{xe “TESDK:MessageCompressThreshold”}

MessageCompressThreshold: Integer;

The MessageCompressThreshold property specifies the compression threshold sizes in bytes of a message. The default MessageCompressThreshold is 250,000 bytes. When constructing messages and using the SetMessageBodyAsRTF method, if the body exceeds the MessageCompressThreshold it is compressed automatically. Compression increases the overall message creation time but can significantly reduce the size of messages with embedded graphics.

CommandAutoClear

{xe “CommandAutoClear”}{xe “TESDK:CommandAutoClear”}

CommandAutoClear: Boolean;

The CommandAutoClear property determines how commands are retained and handled in memory. By default, CommandAutoClear is set to TRUE and commands are not retained in memory once they are sent and commands are not retained in memory once they are received. When sending a command using the SetCommand method, the command information will be cleared from memory when CommandAutoClear is TRUE. Otherwise use the ClearCommand and ClearCommandAll events to clear all commands from memory.

When receiving a command, all command information must be extracted by the client during the OnCommand event using the various GetCommand related methods if CommandAutoClear is TRUE. Once the OnCommand event is complete, the command related information is cleared from memory. To change this behavior, set CommandAutoClear to FALSE.

Connected

{xe “Connected”}{xe “TESDK:Connected”}

property Connected: Boolean;

The Connected property is used to determine if the client has established a socket connection with the real-time server. A value of TRUE indicates a socket connection is established. A value of FALSE indicates the socket is not connected. The Connected property can be used to determine if a real-time client connection is still connected. The OnClientConnected event is used to perform initial communications once a connection is established such as receiving stored messages and sending and receiving of status information for users. The OnClientConnected event occurs after the negotiations are completed and the real-time connection is approved. See the OnClientConnected event for more details.

IP

(xe “IP”}{xe “TESDK:IP}

property IP: String;

The IP property is used to specify the IP address or host name of the real-time server. The IP property holds the IP address portion of the address of the real-time server for establishing a connection.

For example,

MyESDK.IP=“127.0.0.1”

MyESDK. Port=35000

MyESDK. Connect

Port

{xe “Port”}{xe “TESDK:Port”}

property Port: Integer;

The Port property is used to specify the default port of the real-time server. The port is the default port required for clients connecting to the real-time server. The default port for the real-time server is TCP port 35000. The default port can be modified on a real-time server using the server console.

For example,

MyESDK.IP=“127.0.0.1”

MyESDK. Port 35000

MyESDK.Connect

Account

{xe “Account”}{xe “TESDK:Account”}

property Account: String;

The Account property specifies the account name used to logon to the real-time server. The Account and Password are only required if the real-time server has been configured for authentication using the server console. The Account is the name of the user to logon to the real-time server. A Password must also be provided to connect to the real-time server. If the initial provided Account and Password are incorrect or the account and password are not provided, the client will trigger an OnClientLogon event to request the Account and Password. Once the Account and Password are verified, the client will trigger an OnClientUID event to provide the user identification to the client based upon the validated Account and Password.

For example,

MyESDK.IP=“127.0.0.1”

MyESDK.Port 35000

MyESDK.Account=“Account”

MyESDK. Password=“Password”

MyESDK.Connect

Password

{xe “Password”}{xe “TESDK:Password”}

property Password: String;

The Password property specifies the password used to logon to the real-time server. The Account and Password are only required if the real-time server has been configured for authentication using the server console. The Password is the password of the user to logon to the real-time server. An Account must also be provided to connect to the real-time server. If the initial provided Account and Password are incorrect or the account and password are not provided, the client will trigger an OnClientLogon event to request the Account and Password. Once the Account and Password are verified, the client will trigger an OnClientUID event to provide the user identification to the client based upon the validated Account and Password.

For example,

MyESDK. “127.0.0.1”

MyESDK. Port 35000

MyESDK.Account=‘Account’

MyESDK Password=“Password”

MyESDK.Connect

UID

{xe “UID”}{xe “TESDK:UID”}

property UID: String;

The UID is the user identification value of the client user. A UID uniquely identifies the user to the real-time server. Each user must have their own unique UID user identification. The UID should be constant for each respective user and persist between each session they maintain with the real-time server.

The UID information may be maintained in the client application or authentication may be enabled on the real-time server so that the real-time server maintains the UID information. To maintain the UID within the client application, call CreateID at least once to generate a UID value and then retain that value in the client application. The UID must be assigned to the UID property before calling the Connect method. If the real-time server is maintaining the UID, enable user authentication in the real-time server console and provide an Account and Password when the client connects. Once the account and password are verified by the real-time server, a UID will be provided through the OnClientUID event.

Identity

{xe “Identity”}{xe “TESDK:Identity”}

property Identity: String;

The Identity is the visible displayed status name that represents the client user. The Identity is strictly used for display purposes in the status or presence directory.

For example,

MyESDK.Identity=“John Smith”

VCL

{xe “VCL”}{xe “TESDK:VCL”}

property VCL: Boolean;

The VCL property is used to indicate the application is being developed in Delphi and will be using the VCL during real-time events. The real-time software development kit uses threads for maximum socket efficiency for events and internal processes. Since Delphi requires synchronization of thread activity when threads access the VCL, it is necessary to set VCL to TRUE.

For example,

MyESDK.VCL=TRUE

Set VCL to TRUE only if using Delphi and only if the Delphi application accesses the VCL. Console applications and service handler applications on Delphi typically do not access the VCL. Do not set VCL to TRUE on other development platforms as it will prevent communications from operating properly.

Methods

CreateID

{xe “CreateID”}{xe “TESDK:CreateID”}

function CreateID: String;

The CreateID method generates a generic ID string that can be used as a user identifier, channel identifier, command identifier or message identifier within the real-time platform. Under normal circumstances this method does not have to be called directly.

Return Values

If the method succeeds, the return value is an ID string.

If the method fails, the return value is NULL.

GetSecurity

{xe “GetSecurity”}{xe “TESDK:GetSecurity”}

function GetSecurity: String;

The GetSecurity method returns a string that identifies the current encryption method that the real-time server is using. Possible results include RC4, RC4+RSA, DES+RSA, DES3+RSA, AES+RSA. The security policy is automatically handled by the real-time server and is required by all connecting clients. The real-time SDK handles all the security and encryption work automatically.

For RSA based security policies, the client will automatically generate the PKI public and private keys required to communicate with the server. The process of creating keys can take a while, but will insure that each communication session is uniquely encrypted. To avoid the time required to generate keys, save the public and private keys after the first time they are created. Once created, they are retained in the PublicKey and PrivateKey properties. The keys can also be manually generated using the GetCertificateKeys method.

When the real-time client requires the public and private keys it will fire the OnClientCertificateKeys event. An application can respond by passing the previously stored keys back to the client in this event. If the application does not reply to the keys in this event, then the real-time client will make new PKI public and private keys each time they are required. For more information on using and retaining security keys, see the OnClientCertificateKeys event.

Return Values

If the method succeeds, the return value is a string representing the security method.
If the method fails, the return value is the string ‘Unknown’.
   GetCertificateKeys
   {xe “GetCertificateKeys”}{xe “TESDK:GetCertificateKeys”}
   function GetCertificateKeys: Boolean;

The GetCertificateKeys method generates a public and private key pair that is compatible with the real-time server and stores the results in the PublicKey and PrivateKey strings. Under normal circumstances it is not necessary to manually create these keys. If a real-time server has enforced a security policy that requires certificate keys, they will be automatically generated by the real-time SDK on demand. Because the key creation time can be time consuming, it is recommended the keys be saved the first time they are created.

When the real-time client requires the public and private keys it will fire the OnClientCertificateKeys event. The application can respond by passing the previously saved keys back to the client in this event. If the application does not reply to the keys in this event, then the real-time client will make new PKI public and private keys each time they are required. For more information on using and retaining security keys, see the OnClientCertificateKeys event.

Return Values

If the method succeeds, the return value is TRUE.

If the method fails, the return value is FALSE.

CreateChannel

{xe “CreateChannel”}{xe “TESDK:CreateChannel”}

function CreateChannel: String;

The CreateChannel method creates a new in-memory channel record for real-time communications. Use CreateChannel to create a custom in-memory channel for sending and receiving any custom information using the real-time platform. Channels are used within the real-time platform to control where information is routed and which users actually receive the information content. It is not necessary to use channels to access the presence, status and message features of the real-time platform. Channels are only used when creating a custom communications solution.

The real-time servers actually route across geographic boundaries in real-time to deliver content. To add users to the communications channel use the AddUserToChannel method. As many users may be added to a given channel that will participate in the communications. The channel is not actually created on the real-time server until the SetChannel method is invoked. New users may be added to a channel at anytime by subsequent calls to the AddUserToChannel method followed by SetChannel. Simply use the CID previously returned by the call to CreateChannel.

Return Values

If the method succeeds, the return value is the CID string.

If the method fails, the return value is NULL.

AddUserToChannel

{xe “AddUserToChannel”}{xe “TESDK:AddUserToChannel”}

procedure AddUserToChannel (CID: String; UID: String);

The AddUserToChannel method joins a user to a given in-memory channel record. In order to have the join be processed by the server, call the SetChannel method. To destroy a channel and clear all the users from the channel, call the SetChannelLeaveAll method.

Parameters

CID

A string representing the channel identifier.

UID

A string representing the user identifier.

DeleteUserFromChannel

{xe “DeleteUserFromChannel”}{xe “TESDK:DeleteUserFromChannel}

procedure DeleteUserFromChannel (CID: String; UID: String);

The DeleteUserFromChannel method removes a user from a given channel in-memory channel record. This method is only effective at removing users from an in-memory channel record before a call to SetChannel. To destroy a channel and clear all the users from the channel on a real-time server, call the SetChannelLeaveAll method instead.

Parameters

CID

A string representing the channel identifier.

UID

A string representing the user identifier.

SetChannel

{xe “SetChannel”}{xe “TESDK:SetChannel”}

function SetChannel (CID: String): Boolean;

The SetChannel method invokes the in-memory channel and all the users assigned to the channel with the real-time server. To send information or content to the channel, see the CreateCommand and its related methods. Channels are used within the real-time platform to control where information is routed and which users actually receive the information content. It is not necessary to use channels to access the presence, status and message features of the real-time platform. They are only used when creating a custom communications solution. The real-time servers actually route across geographic boundaries in real-time to deliver the content. To add users to the communications in-memory channel use the AddUserToChannel method.

Parameters

CID

A string representing the channel.

Return Values

If the method succeeds, the return value is TRUE.

If the method fails, the return value is FALSE.

SetChannelLeaveAll

{xe “SetChannelLeaveAll”}{xe “TESDK:SetChannelLeaveAll”}

function SetChannelLeaveAll(CID: String): Boolean;

The SetChannelLeaveAll method destroys the channel and removes all users from the channel with the real-time server.

Parameters

CID

A string representing the channel identifier.

Return Values

If the method succeeds, the return value is TRUE.

If the method fails, the return value is FALSE.

GetChannelCount

{xe “GetChannelCount”}{xe “TESDK:GetChannelCount”}

function GetChannelCount: Integer;

The GetChannelCount method returns the total number of in-memory channel records that have been defined within the real-time client. Once a channel has been activated with the real-time server using SetChannel, that in-memory channel record may be cleared using either the ClearChannel or ClearChannelAll methods.

Return Values

If the method succeeds, the return value is an integer channel count.

If the method fails, the return value is 0.

GetChannelCID

{xe “GetChannelCID”}{xe “TESDK:GetChannelCID”}

function GetChannelCID(Index: Integer): String;

The GetChannelCID method returns the CID associated with a given in-memory channel based upon the in-memory channel index. To determine the total count of channels in memory, call the GetChannelCount method. Channel indexes are relative to zero in memory. To walk the entire channel listing in memory, start at zero and go to GetChannelCount minus one.

Parameters

Index

An integer representing the in channel index.

Return Values

If the method succeeds, the return value is the CID string.

If the method fails, the return value is NULL.

ClearChannel

{xe “ClearChannel”}{xe “TESDK:ClearChannel”}

procedure ClearChannel(CID: String);’

The ClearChannel method deletes an in-memory channel.

Parameters

CID

A string representing the channel identifier.

ClearChannelAll

{xe “ClearChannelAll”}{xe “TESDK:ClearChannelAll”}

procedure ClearChannelAll;

The ClearChannelAll method deletes all in-memory channel records.

CreateCommand

{xe “CreateCommand”}{xe “TESDK:CreateCommand”}

function CreateCommand: String;

The CreateCommand method creates a new in-memory command record for real-time communications. Commands are sequences of data and information that are relayed to a channel, routed within the real-time environment and received by the real-time client. A channel should already be established using the SetChannel method before sending a command using SetCommand. For more information on channels, see the SetChannel method.

Return Values

If the method succeeds, the return value is the RID string.

If the method fails, the return value is NULL.

SetCommand

{xe “SetCommand”}{xe “TESDK:SetCommand”}

function SetCommand(RID, CID: String): Boolean;

The SetCommand method sends a custom command to the real-time server. If a custom command has been fully constructed and is ready to be sent to the real-time server, call this method. Commands are constructed using the SetCommandString, SetCommand Integer, SetCommandBoolean, SetCommandDateTime and SetCommandStream methods. Commands are sent to channels that have been created and already established through the SetChannel method. A command must also include a command value to identify it to the real-time routing engine of the ESDK. Call the SetCommandCMD method to assign a command value.

Parameters

RID

A string representing the command identification value.

CID

A string representing the channel identification value.

Return Values

If the method succeeds, the return value is TRUE.

If the method fails, the return value is FALSE.

SetCommandString

{xe “SetCommandString”}{xe “TESDK:SetCommandString”}

procedure SetCommandString(RID: String; Prop: Integer; Value: String);

The SetCommand String method sets a string property of a command. To change a command, provide the property and a new value. Constructing a command involves adding various details to a created command. In order to have the command sent to the real-time server, call the SetCommand method.

For example,

MyESDK.SetCommandString(RID, 10000, “Hello World”)

The RID represents the command identifier that was obtained by calling the method CreateCommand. The property value 10000 is a property that is user defined within the command.

Parameters

RID

The command identifier of the command.

Prop

An integer representing the property.

Value

A string representing the value assigned to the property.

SetCommandInteger

{xe “SetCommandInteger”}{xe “TESDK:SetCommandInteger”}

procedure SetCommandInteger(RID: String; Prop: Integer; Value: Integer);

The SetCommand Integer method sets an integer property of a command. To change a command, provide the property and a new value, Constructing a command involves adding various details to a created command. In order to have the command sent to the real-time server, call the SetCommand method.

For example,

MyESDK.SetCommandInteger(R1, 001, 101)

The RID represents the command identifier that was obtained by calling the method CreateCommand. The property value 10001 is a property that is user defined within the command.

Parameters

RID

The command identifier of the command.

Prop

An integer representing the property.

Value

An integer representing the value assigned to the property.

SetCommand Boolean

{xe “SetCommandBoolean”}{xe “TESDK:SetCommandBoolean”}

procedure SetCommandBoolean(RID: String; Prop: Integer; Value: Boolean);

The SetCommandBoolean method sets a boolean property of a command. To change a command, provide the property and a new value. Constructing a command involves adding various details to a created command. In order to have the command sent to the real-time server, call the SetCommand method.

For example,

MyESDK.SetCommandBoolean(RID, 10002, FALSE)

The RID represents the command identifier that was obtained by calling the method CreateCommand. The property value 10002 is a property that is user defined within the command.

Parameters

RID

The command identifier of the command.

Prop

An integer representing the property.

Valve

A boolean representing the value assigned to the property.

SetCommandDateTime

{xe “SetCommandDateTime”}{xe “TESDK:SetCommandDateTime”}

procedure SetCommandDateTime(RID: String; Prop: Integer; Value: TDateTime);

The SetCommandDateTime method sets a datetime property of a command. To change a command, provide the property and a new value. Constructing a command involves adding various details to a created command. In order to have the command sent to the real-time server, call the SetCommand method.

For example,

MyESDK.SetCommandDateTime(RID, 10003, Now)

The RID represents the command identifier that was obtained by calling the method CreateCommand. The property value 10003 is a property that is user defined within the command.

Parameters

RID

The command identifier of the command.

Prop

An integer representing the property.

Value

A datetime representing the value assigned to the property.

SetCommandStream

{“SetCommandStream”}{xe “TESDK:SetCommandStream”}

procedure SetCommandStream(RID: String; Prop: Integer; Value: TMemoryStream);

The SetCommandStream method sets a stream property of a command. To change a command, provide the property and a new value. Constructing a command involves adding various details to a created command. In order to have the command sent to the real-time server, call the SetCommand method.

For example,

MyESDK.SetCommandStream(RID, 10004, MyStream)

The RID represents the command identifier that was obtained by calling the method CreateCommand. The property value 10004 is a property that is user defined within the command.

Streams are designed for compatibility with Borland development environments. For Microsoft development environments, SetCommandOleVariant may be needed instead.

Parameters

RID

The command identifier of the command.

Prop

An integer representing the property.

Value

A stream representing the value assigned to the property.

SetCommandOleVariant

{xe “SetCommandOleVariant”}{xe “TESDK:SetCommandOleVariant”}

procedure SetCommandOleVariant(RID: String; Prop: Integer; Value: OleVariant);

The SetCommandOleVariant method sets an olevariant property of a command. To change a command, provide the property and a new value. Constructing a command involves adding various details to a created command. In order to have the command sent to the real server, call the SetCommand method.

For example,

MyESDK.SetCommandOleVariant(RID, 10005, MyOleVariant)

The RID represents the command identifier that was obtained by calling the method CreateCommand. The property value 10005 is a property that is user defined within the command.

Parameters

RID

The command identifier of the command.

Prop

An integer representing the property.

Value

An olevariant representing the value assigned to the property.

SetCommandCMD

{xe “SetCommandCMD”}{xe “TESDK:SetCommandCMD”}

procedure SetCommandCMD(RID: String; CMD: Integer);

The SetCommandCMD assigns a command value to a command. Each command that is user defined must contain a command value. The command value is extracted during the OnCommand event using the GetCommandCMD method. The command value is user defined by the developer to determine the type of information being received. Starting user defined command values at 50000 is recommended.

For example,

MyESDK.SetCommandCMD(RID, 50000)

The RID represents the command identifier that was obtained by calling the method CreateCommand. The command value 50000 is a user defined value.

Parameters

RID

The command identifier of the command.

CMD

An integer representing the command value.

GetCommandString

{xe “GetCommandString”}{xe “TESDK:GetCommandString”}

function GetCommandString(RID: String; Prop: Integer): String;

The GetCommandString method gets a property string from a received command. To retrieve a string from a received command, provide the RID of the command record and the property value of the string.

For example,

MyString=MyESDK.GetCommandString(RID, 10000)

The property value 10000 represents the user defined string. To determine the command value associated with the command identifier, call the GetCommandCMD method.

Parameters

RID

A string representing the command identification value.

Prop

An integer representing the property value of the string.

Return Values

If the method succeeds, the return value is the string value of the specified property.

If the method fails, the return value is NULL.

GetCommandInteger

{xe “GetCommandInteger”}{xe “TESDK:GetCommandInteger”

function GetCommandInteger(RID: String; Prop: Integer): Integer;

The GetCommandInteger method gets a property integer from a received command. To retrieve an integer from a received command, provide the RID of the command record and the property value of the integer.

For example,

MyInteger=MyESDK.GetCommandInteger(RID, 10001)

The property value 10001 represents the user defined integer. To determine the command value associated with the command identifier, call the GetCommandCMD method.

Parameters

RID

A string representing the command identification value.

Prop

An integer representing the property value of the integer.

Return Values

If the method succeeds, the return value is the integer value of the specified property.

If the method fails, the return value is 0.

GetCommandBoolean

{xe “GetCommandBoolean”}{“TESDK:GetCommandBoolean”}

function GetCommandBoolean(RID: String; Prop: Integer): Boolean;

The GetCommandBoolean method gets a property boolean from a received command. To retrieve a boolean from a received command, provide the RID of the command record and the property value of the boolean.

For example,

MyBool=MyESDK.GetCommandBoolean(RID, 10002)

The property value 10002 represents the user defined boolean. To determine the command value associated with the command identifier, call the GetCommandCMD method.

Parameters

RID

A string representing the command identification value.

Prop

An integer representing the property value of the boolean.

Return Values

If the method succeeds, the return value is the boolean value of the specified property.

If the method fails, the return value is FALSE.

GetCommandDateTime

{xe “GetCommandDateTime”}{xe “TESDK:GetCommandDateTime”}

function GetCommandDateTime(RID: String; Prop: Integer): TDateTime;

The GetCommandDateTime method gets a property datetime from a received command. To retrieve a datetime from a received command, provide the RID of the command record and the property value of the datetime.

For example,

MyDateTime=MyESDK.GetCommandDateTime(RID, 10003)

The property value 10003 represents the user defined datetime. To determine the command value associated with the command identifier, call the GetCommandCMD method.

Parameters

RID

A string representing the command identification value.

Prop

An integer representing the property value of the datetime.

Return Values

If the method succeeds, the return value is the datetime value of the specified property.

If the method fails, the return value is 0.

GetCommandStream

{xe “GetCommandStream}{xe “TESDK:GetCommandStream”}

function GetCommandStream(RID: String; Prop: Integer): TMemoryStream;

The GetCommandStream method gets a property stream from a received command. To retrieve a stream from a received command, provide the RID of the command record and the property value of the stream.

For example,

MyStream=MyESDK.GetCommandStream(RID, 10004)

The property value 10004 represents the user defined stream. To determine the command value associated with the command identifier, call the GetCommandCMD method.

Streams are designed for compatibility with Borland development environments. For Microsoft development environments, GetCommandOleVariant may be needed instead.

Parameters

A string representing the command identification value.

Prop

An integer representing the property value of the stream.

Return Values

If the method succeeds, the return value is the stream value of the specified property.

If the method fails, the return value is NIL.

GetCommandOleVariant

{xe “GetCommandOleVariant”}{xe “TESDK:GetCommandOleVariant”}

function GetCommandOleVariant(RID: String; Prop: Integer): OleVariant;

The GetCommandOleVariant method gets a property olevariant from a received command. To retrieve an olevariant from a received command, provide the RID of the command record and the property value of the olevariant.

For example,

MyOleVariant=MyESDK.GetCommandOleVariant(RID, 10005)

The property value 10005 represents the user defined olevariant. To determine the command value associated with the command identifier, call the GetCommandCMD method.

Parameters

RID

A string representing the command identification value.

Prop

An integer representing the property value of the olevariant.

Return Values

If the method succeeds, the return value is the olevariant value of the specified property.

If the method fails, the return value is NIL.

GetCommandCount

{xe “GetCommandCount”}{xe “TESDK:GetCommandCount”}

function GetCommandCount: Integer;

The GetCommandCount method returns the total number of in-memory commands within the real-time client. The real-time client keeps track of received and sent commands in memory. Commands are automatically cleared from memory if CommandAutoClear is TRUE once the command is received and after the OnCommand event or the command is sent using SetCommand. To manually clear in-memory command records, see the ClearCommand and ClearCommandAll methods.

Return Values

If the method succeeds, the return value is an integer command count.

If the method fails, the return value is 0.

GetCommandRID

{xe “GetCommandRID”}{xe “TESDK:GetCommandRID”}

function GetCommandRID(Index: Integer) String;

The GetCommand RID method returns the RID associated with a given in-memory command based upon the in-memory command index. To determine the total count of commands in memory, call the GetCommandCount method. Command indexes are relative to zero in memory. To walk the entire command listing in memory, start at zero and go to GetCommandCount minus one.

Parameters

Index

An integer representing the in-memory command index.

Return Values

If the method succeeds, the return value is the RID string.

If the method fails, the return value is NULL.

GetCommandCMD

{xe “GetCommandCMD”}{xe “TESDK:GetCommandCMD”}

function GetCommandCMD(RID: String): Integer;

The GetCommandCMD method returns the command value associated with a given in-memory command based upon the command identification.

Parameters

RID

A string representing the command identification value.

Return Values

If the method succeeds, the return value is the command value integer.

If the method fails, the return value is 0.

ExistCommandProp

{xe “ExistCommandProp”}{xe “TESDK:ExistCommandProp”}

function ExistCommandProp(RID: String; Prop: Integer): Boolean;

The ExistCommandProp method checks for the existence of a property within an in-memory command.

Parameters

RID

A string representing the command identification value.

Prop

An integer representing the property value.

Return Values

If the method succeeds, the return value is TRUE.

If the method fails, the return value is FALSE.

ExistCommand

{xe “ExistCommand”}{xe “TESDK:ExistCommand”}

function ExistCommand(RID: String): Boolean;

The ExistCommand method checks for the existence of an in-memory command.

Parameters

RID

A string representing the command identification value.

Return Values

If the method succeeds, the return value is TRUE.

If the method fails, the return value is FALSE.

ClearCommand

{xe “ClearCommand”}{xe “TESDK:ClearCommand”}

procedure ClearCommand (RID: String);

The ClearCommand method clears an in-memory command.

Parameters

RID

A string representing the command identification value.

ClearCommandAll

{xe “ClearCommandAll”}{xe “TESDK:ClearCommandAll”}

procedure ClearCommandAll;

The ClearCommandAll method clears all in-memory commands.

SetStatus

{xe “SetStatus”}{xe “TESDK:SetStatus”}

function SetStatus: Boolean;

The SetStatus method announces the client's personal in-memory status to the real-time server. All status values assigned are automatically sent to the server. To assign values to in-memory status, see SetStatusString, SetStatusInteger, SetStatusBoolean and SetStatusDateTime.

Return Values

If the method succeeds, the return value is TRUE.

If the method fails, the return value is FALSE.

SetStatusMode

{xe “SetStatusMode”}{xe “TESDK:SetStatusMode”}

function SetStatusMode(Mode: Integer) Boolean;

The SetStatusMode changes the status operating mode of the real-time client. The real-time client supports two modes of operation for how status information is received from other users. By default the real-time client operates in full mode (T_STATUS_FULL). In full mode, all status information for all users within the real-time communications network is received by the real-time client through the OnStatus event automatically. It is not necessary to use the GetStatusRequest method. This is limited in an enterprise real-time environment through the use of profiles that are created with the server console on the real-time server. By implementing full status mode, an enterprise product is essentially created where the majority of user and group management will occur on the real-time server through the real-time server's management console.

The other operating mode is known as partial mode (T_STATUS_PARTIAL). In partial mode, only status information is received for users requested using the GetStatusRequest method. By implementing partial status mode an enterprise product is essentially created that operates in a subscriber model like most consumer IM products.

For example,

MyESDK.SetStatusMode(1)

The status mode 1 (T_MODE_PAL) represents the partial status mode value. For a listing of all property values, see Status Constants.

Once status is requested for a given user in partial status mode, or if using full status mode, all subsequent status changes for that user will be received through the OnStatus event.

Parameters

Mode

A integer representing the status operating mode.

Return Values

If the method succeeds, the return value is TRUE.

If the method fails, the return value is FALSE.

SetStatusString

{xe “SetStatusString”}{xe “TESDK:SetStatusString”}

procedure SetStatusString(Prop: Integer; Value: String);

The SetStatusString method sets a property string in personal in-memory status. To change in-memory status, provide the property and a new value. In order to have status processed by the real-time server after making any changes, call the SetStatus method.

For example,

MyESDK.SetStatusString(100, “Online”)

MyESDK. SetStatus

The property value 100 (T_STATUS_MSG) represents the status presence message that is displayed in the directory next to the user's identity. For a listing of all property values, see Status constants. To create extensible custom status properties, see creating a custom status property.

Parameters

Prop

A integer representing the property.

Value

A string representing the value assigned to the property.

SetStatusInteger

{xe “SetStatusInteger”}{xe “TESDK:SetStatusInteger”}

procedure SetStatusInteger(Prop: Integer; Value: Integer);

The SetStatusInteger method sets a property string in personal in-memory status. To change in-memory status, provide the property and a new value. In order to have status processed by the real-time server after making any changes, call the SetStatus method.

For example,

MyESDK. SetStatusInteger(101, 1)

MyESDK.SetStatus

The property value 101 (T_STATUS_STI) represents the status presence image icon that is displayed in the directory next to the user's identity. The value 1 (STA_ON) tells the client to use the green, online user icon. For a complete listing of all property values, see Status constants. To create extensible custom status properties, see creating a custom status property.

Parameters

Prop

A integer representing the property.

Value

An integer representing the value assigned to the property.

SetStatusBoolean

{xe “SetStatusBoolean”}{xe “TESDK:SetStatusBoolean”}

procedure SetStatusBoolean(Prop: Integer; Value: Boolean);

The SetStatusBoolean method sets a property boolean in personal in-memory status. To change in-memory status, provide the property and a new value. In order to have status processed by the real-time server after making any changes, call the SetStatus method. For a listing property values, see Status constants. To create extensible custom status properties, see creating a custom status property.

Parameters

Prop

A integer representing the property.

Value

A boolean representing the value assigned to the property.

SetStatusDateTime

{xe “SetStatusDateTime”}{xe “TESDK:SetStatusDateTime”}

procedure SetStatusDateTime(Prop: Integer; Value: TDateTime);

The SetStatusDateTime method sets a property datetime in personal in-memory status. To change in-memory status, provide the property and a new value. In order to have status processed by the real-time server after making any changes, call the SetStatus method.

For example,

MyESDK.SetStatusDateTime(110, Now)

MyESDK.SetStatus

The property value 110 (T-STATUS_TIME) represents the status presence current time that could be displayed in the directory next to the user's identity. For a listing property values, see status constants, below. To create extensible custom status properties, see creating a custom status property.

Parameters

Prop

A integer representing the property.

Value

A datetime representing the value assigned to the property.

GetStatusRequestAll

{xe “GetStatusReQuestAll”{xe “TESDK:GetStatusReQuestAll”}

function GetStatusRequestAll: Boolean;

The GetStatusRequestAll method requests all status information for all users from the real-time server. To obtain a complete listing of the status of all users from the real-time server use this method. The status information is received in the OnStatus event. A call to GetStatusRequestAll only provides a listing of users with their current status and does not imply tracking status changes for these users. In order to track the status changes of users, either use full status mode with the SetStatusMode method or request status tracking by using the GetStatusRequest method. The status information returned by this method is limited by any profile restrictions imposed through the real-time server.

Return Values

If the method succeeds, the return value is TRUE.

If the method fails, the return value is FALSE.

GetStatusRequestQuery

{xe “GetStatusRequestQuery”}{xe “TESDK:GetStatusRequestQuery”

function GetStatusRequestQuery(Query: String): Boolean;

The GetStatusRequestQuery method requests status information for partially matching users from the real-time server. To obtain a listing of the status of all users who partially match the query parameter, use this method. The status information is received in the OnStatus event. A call to GetStatusRequestQuery only provides a listing of users with their current status and does not imply that the client will be tracking status changes for these users. In order to track the status changes of users, either use full status mode with the SetStatusMode method or request status tracking by using the GetStatusRequest method. The status information returned by this method is limited by any profile restrictions imposed through the real-time server.

Parameters

Query

A search string representing a partial identity.

Return Values

If the method succeeds, the return value is TRUE.

If the method fails, the return value is FALSE.

GetStatusRequest

{xe “GetStatusRequest”}{xe “TESDK:GetStatusRequest”}

function GetStatusRequest(UID: String): Boolean;

The GetStatusRequest method requests status information and tracking for the specified UID from the real-time server. A call to GetStatusRequest will immediately request the current status of the requested UID. Additionally, any status changes that happen for the given UID will automatically be received. All of these status changes occur through the use of the OnStatus event. It is only necessary to use this method in partial status mode. See SetStatusMode for more details on changing the status operating mode.

Parameters

UID

A string representing the user identification.

Return Values

If the method succeeds, the return value is TRUE.

If the method fails, the return value is FALSE.

GetStatusCount

{xe “GetStatusCount”}{xe “TESDK:GetStatusCount”}

function GetStatusCount: Integer;

The GetStatusCount method returns the total number of in-memory status records that have been received within the real-time client. The real-time client keeps track of the current status information for users in memory provided that either using full status operating mode is being used or status tracking using GetStatusRequest in partial status operating mode has been requested. For more information on changing the status operating mode see SetStatusMode. To clear all in-memory status records, see the ClearStatusAll method.

Return Values

If the method succeeds, the return value is an integer status count.

If the method fails, the return value is 0.

GetStatusUID

{xe “GetStatusUID”}{xe “TESDK:GetStatusUID”}

function GetStatusUID(Index: integer): String;

The GetStatusUID method returns the UID associated with a given in-memory status based upon the in-memory status index. To determine the total count of statuses in memory, call the GetStatusCount method. Status indexes are relative to zero in memory. To walk the entire status listing in memory, start at zero and go to GetStatusCount minus one.

Parameters

Index

An integer representing the in-memory status index.

Return Values

If the method succeeds, the return value is the UID string.

If the method fails, the return value is NULL.

GetStatusString

{xe “GetStatusString”}{xe “TESDK:GetStatusString”}

function GetStatusString(UID: String; Prop: Integer): String;

The GetStatusString method gets a property string from an in-memory status record. To retrieve a string from an in-memory status record, provide the UID of the status record and the property value of the string.

For example,

Identity=MyESDK.GetStatusString(UID, 103)

The property value 103 (T_STATUS_IDENTITY) represents the identity or displayed name in the directory for the given UID. For a listing property values, see Status constants. To create extensible custom status properties, see creating a custom status property.

Parameters

UID

A string representing the user identification value.

Prop

An integer representing the property value of the string.

Return Values

If the method succeeds, the return value is the string value of the specified property.

If the method fails, the return value is NULL.

GetStatusInteger

{xe “GetStatusInteger”}{xe “TESDK:GetStatusIntegere”}

function GetStatusInteger (UID: String; Prop: Integer): Integer;

The GetStatusInteger method gets a property integer from an in-memory status record. To retrieve an integer from an in-memory status record, provide the UID of the status record and the property value of the integer.

For example,

State=MyESDK. GetStatusInteger(UID, 101)

The property value 101 (T_STATUS_STATE) represents the state in the directory for the given UID. The state is the type of icon that is displayed next to a given name for their current status state (ex: Do not disturb). For a listing property values, see Status constants. To create custom status properties, see How to Creating a Custom Status Property.

Parameters

UID

A string representing the user identification value.

Prop

An integer representing the property value of the string.

Return Values

If the method succeeds, the return value is the integer value of the specified property.

If the method fails, the return value is 0.

GetStatusBoolean

{xe “GetStatusBoolean”}{xe “TESDK:GetStatusBoolean”}

function GetStatusBoolean(UID: String; Prop: Integer): Boolean;

The GetStatusBoolean method gets a property boolean from an in-memory status record. To retrieve a boolean from an in-memory status record, provide the UID of the status record and the property value of the boolean. For a listing property values, see Status constants, below. To create extensible custom status properties, see How to Creating a Custom Status Property.

Parameters

UID

A string representing the user identification value.

Prop

An integer representing the property value of the boolean.

Return Values

If the method succeeds, the return value is the boolean value of the specified property.

If the method fails, the return value is FALSE.

GetStatusDateTime

{xe “GetStatusDateTime”}{xe “TESDK:GetStatusDateTime”}

function GetStatusDateTime (UID: String; Prop: Integer): TDateTime;

The GetStatusDateTime method gets a property datetime from an in-memory status record. To retrieve a datetime from an in-memory status record, provide the UID of the status record and the property value of the datetime.

For example,

Time=MyESDK.GetStatusDateTime(UID, 110)

The property value 110 (T_STATUS_TIME) represents the date and time in the directory for the given UID. For a listing property values, see Status constants. To create custom status properties, see creating a custom status property.

Parameters

UID

A string representing the user identification value.

Prop

An integer representing the property value of the datetime.

Return Values

If the method succeeds, the return value is the datetime value of the specified property.

If the method fails, the return value is 0.

GetStatusGroupCount

{xe “GetStatusGroupCount”}{xe “TESDK:GetStatusGroupCount”

The GetStatusGroupCount method returns the total number of in-memory groups associated with the specified in-memory user. To extract the group names associated with any particular index, see GetStatusGroup.

Parameters

UID

A string representing the user identification value.

Return Values

If the method succeeds, the return value is an integer group count for the respective user.

If the method fails, the return value is 0.

GetStatusGroup

{xe “GetStatusGroup”}{xe “TESDK:GetStatusGroup”}

The GetStatusGroup method returns the group name associated with a given in-memory user based upon the group index. To determine the total count of groups related to a user in memory, call the GetStatusGroupCount method. Indexes are relative to zero in memory. To check the entire recipient list in memory, start at zero and go to GetStatusGroupCount minus one.

Parameters

UID

A string representing the user identification value.

Index

An integer representing the in-memory group index.

Return Values

If the method succeeds, the return value is a string representing the group name.

If the method fails, the return value is NULL.

ExistStatusProp

{xe “ExistStatusProp”}{xe “TESDK:ExistStatusProp”}

function ExistStatusProp(UID: String; Prop: Integer): Boolean;

The ExistStatusProp method checks for the existence of a property within an in-memory status record. This method can be used to check for the existence of a property in an in-memory status record. The method can be used for both common status properties and custom status properties. For a listing property values, see Status constants. To create custom status properties, see creating a custom status property.

Parameters

UID

A string representing the user identification value.

Prop

An integer representing the property value.

Return Values

If the method succeeds, the return value is TRUE.

If the method fails, the return value is FALSE.

ExistStatus

{xe “ExistStatus”}{xe “TESDK:ExistStatus”}

function ExistStatus(UID: String): Boolean;

The ExistStatus method checks for the existence of a given in-memory user status record.

Parameters

UID

A string representing the user identification value.

Return Values

If the method succeeds, the return value is TRUE

If the method fails, the return value is FALSE.

ClearStatusAll

{xe “ClearStatusAll”}{xe “TESDK:ClearStatusAll”}

procedure ClearStatusAll;

The ClearStatusAll method clears all in-memory status records. The status records are only removed from the local in-memory and can be refreshed at anytime by calling GetStatusRequestAll, GetStatusRequestQuery or GetStatusRequest.

ClearStatusGroups

{xe “ClearStatusGroups”}{xe “TESDK:ClearStatusGroups”}

procedure ClearStatusGroups;

The ClearStatusGroups method clears all groups from personal in-memory status.

ClearStatusProperties

{xe “ClearStatusProperties”}{xe “TESDK:ClearStatusProperties”

procedure ClearStatusProperties;

The ClearStatusProperties method clears all custom properties from personal in-memory status.

CreateMessage

{xe “CreateMessage”}{xe “TESDK:CreateMessage”}

function CreateMessage: String;

The CreateMessage method creates a new in-memory message record. Use CreateMessage to create a custom in-memory message for sending messages to the real-time server. When constructing a message to be sent, start by creating a message in-memory. The CreateMessage method returns a string which represents the MID of the created message.

For example,

MID=MyESDK.CreateMessage

For more information on sending messages, see How to Send a message.

Return Values

If the method succeeds, the return value is the MID string.

If the method fails, the return value is NULL.

SetMessage

{xe “SetMessage”}{“TESDK:SetMessage”}

function SetMessage(MID: String): Boolean;

The SetMessage sends an in-memory message to the real-time server. If a message has been fully constructed and is ready to be sent to the real-time server, call this method. For more information on sending messages, see How to Send a Message.

Parameters

MID

A string representing the message identification value.

Return Values

If the method succeeds, the return value is TRUE.

If the method fails, the return value is FALSE.

SetMessageString

{xe “SetMessageString”}{xe “TESDK:SetMessageString”}

procedure SetMessageString(MID: String; Prop: Integer; Value: String);

The SetMessageString method sets an in-memory property string. To change an in-memory message, provide the property and a new value. Constructing a message involves adding various details to a created message. For more information on sending messages, see How To Send a Message. In order to have the message sent to the real-time server, call the SetMessage method.

For example,

MyESDK.SetMessageString(MID, 105, “My Subject”)

The MID represents the message identifier that was obtained by calling the method CreateMessage. The property value 105 (T_MESSAGE_SUBJECT) represents the subject of the message. For a listing property values, see Message constants. To create extensible custom message properties, see How to Create a Custom Message Property.

Parameters

MID

The message identifier of the message.

Prop

A integer representing the property.

Value

A string representing the value assigned to the property.

SetMessageInteger

{xe “SetMessageInteger”}{xe “TESDK:SetMessageInteger”}

procedure SetMessageInteger(MID: String; Prop: Integer; Value: Integer);

The SetMessageInteger method sets an in-memory property integer. To change an in-memory message, provide the property and a new value. Constructing a message involves adding various details to a created message. For more information on sending messages, see How To Send a Message. In order to have the message sent to the real-time server, call the SetMessage method. For a listing property values, see Message constants. To create extensible custom message properties, see How to Create a Custom Message Property.

Parameters

MID

The message identifier of the message.

Prop

A integer representing the property.

Value

An integer representing the value assigned to the property.

SetMessageBoolean

{xe “SetMessageBoolean”}{xe “TESDK:SetMessageBoolean”}

procedure SetMessageBoolean(MID: String; Prop: Integer; Value: Boolean);

The SetMessageBoolean sets an in-memory property boolean. To change an in-memory message, provide the property and a new value. Constructing a message involves adding various details to a created message. For more information on sending messages, see How to Send a Message. In order to have the message sent to the real-time server, call the SetMessage method. For a listing property values, see Message constants. To create extensible custom message properties, see How to Create a Custom Message Property.

Parameters

MID

The message identifier of the message.

Prop

A integer representing the property.

Value

A boolean representing the value assigned to the property.

SetMessageDateTime

{xe “SetMessageDateTime”}{xe “TESDK:SetMessageDateTime”}

procedure SetMessageDateTime(MID: String; Prop: Integer; Value: TDateTime);

The SetMessageDateTime method sets an in-memory property datetime. To change an in-memory message, provide the property and a new value. Constructing a message involves adding various details to a created message. For more information on sending messages, see How To Send a Message. In order to have the message sent to the real-time server, call the SetMessage method.

For example,

MyESDK.SetMessageDateTime(MID,1 06,Now)

The MID represents the message identifier that was obtained by calling the method CreateMessage. The property value 106 (T_MESSAGE_SENT) represents the date and time the message was sent. For a listing property values, see Message constants. To create extensible custom message properties, see How to Create a Custom Message Property.

Parameters

MID

The message identifier of the message.

Prop

A integer representing the property.

Value

A datetime representing the value assigned to the property.

SetMessageStream

{xe “SetMessageStream”}{xe “TESDK:SetMessageStream”}

procedure SetMessageStream(MID: String; Prop: Integer; Value: TMemoryStream);

The SetMessageStream method sets an in-memory property stream. To change an in-memory message, provide the property and a new value. Constructing a message involves adding various details to a created message. For more information on sending messages, see How to Send a Message. In order to have the message sent to the real-time server, call the SetMessage method. Streams are designed for compatibility with Borland development environments. For Microsoft development environments, SetMessageOleVariant may be needed instead. For a listing property values, see Message constants. To create extensible custom message properties, see How to Create a Custom Message Property.

Parameters

MID

The message identifier of the message.

Prop

A integer representing the property.

Value

A stream representing the value assigned to the property.

SetMessageOleVariant

{xe “SetMessageOleVariant”}{xe “TESDK:SetMessageOleVariant”}

procedure SetMessageOleVariant(MID: String; Prop: Integer; Value: OleVariant);

The SetMessageOleVariant method sets an in-memory property olevariant. To change an in-memory message, provide the property and a new value. Constructing a message involves adding various details to a created message. For more information on sending messages, see How to Send a Message. In order to have the message sent to the real-time server, call the SetMessage method. OleVariants are designed for compatibility with Microsoft development environments. For Borland development environments, choose to use SetMessageStream instead. For a listing property values, see Message constants. To create extensible custom message properties, see How to Create a Custom Message Property.

Parameters

MID

The message identifier of the message.

Prop

A integer representing the property.

Value

An olevariant representing the value assigned to the property.

SetMessageBodyAsRTF

{xe “SetMessageBodyAsRTF”}{xe “TESDK:SetMessageBodyAsRTF”}

procedure SetMessageBodyAsRTF(MID: String; Value: String);

The SetMessageBodyAsRTF method assigns rich text formatted content to a message body. This method takes rich text with fonts, colors and graphics, embedded images and objects and applies the content as the body of the message. To use this method, simply transfer the content of a RichEdit control or component to a string. The string can then be directly assigned to the SetMessageBodyAsRTF method.

Constructing a message involves adding various details to a created message. For more information on sending messages, see How To Send a Message. In order to have message sent to the real-time server, call the SetMessage method.

Parameters

MID

The message identifier of the message.

Value

A string comprised of rich text formatted content.

SetMessageBodyAsText

{xe “SetMessageBodyAsText”}{xe “TESDK:SetMessageBodyAsText

procedure SetMessageBodyAsText (MID: String; Value: String);

The SetMessageBodyAsText method assigns plain text content to a message body. This method takes plain text, converts it to simple rich text and applies the content as the body of the message. To apply carriage returns in the body of the text, include the characters LF (10) and CR (13) together within the string.

Constructing a message involves adding various details to a created message. For more information on sending messages, see How to Send a Message. In order to have the message sent to the real-time server, call the SetMessage method.

Parameters

MID

The message identifier of the message.

Value

A string comprised of rich text formatted content.

SetMessageRecipient

{xe “SetMessageRecipient”}{xe “TESDK:SetMessageRecipient”}

procedure SetMessageRecipient (MID: String; Value: String; UID: String);

The SetMessageRecipient method adds a recipient to a message. This method is used to add a recipient to the recipients list for a message. In order to add a recipient, supply a descriptive name and UID.

For example,

MyESDK.SetMessageRecipient(Ml D, Smith”, UID)

Subsequent calls to SetMessageRecipient will add more users to the recipient list. A typical recipient uses the Identity as the descriptive name associated with a single UID. However, the SetMessageRecipient method supports the ability to associate multiple different UIDs with a single common descriptive name. This would be used when creating a group that contains more than a single UID as a recipient for a message. To clear all the recipients from a message, call the ClearMessageRecipients method.

Parameters

MID

A string representing the message identifier of the message.

Value

A string representing the descriptive name for the recipient.

UID

A string representing the UID of the recipient.

SetMessageAttachmentAsFile

{xe “SetMessageAttachmentAsFile”}{xe

“TESDK:SetMessageAttachmentAsFile”}

function SetMessageAttachmentAsFile (MID: String; Name: String): Boolean;

The SetMessageAttachmentAsFile attaches a file to a message from a given path. This method will attach and compress a file to a message based upon the given path.

For example,

MyESDK.SetMessageAttachmentAsFile(MID,“C: .BAT”)

Attachments are automatically compressed as they are included with the message. To attach a message from data that is already in memory see SetMessageAttachmentAsStream or SetMessageAttachmentAsOleVariant. To extract a message, upon receipt, use the GetMessageAttachmentAsFile method. To clear all the attachments from a message, call the ClearMessageAttachments method.

Parameters

MID

A string representing the message identifier of the message.

Name

A string representing the path and filename of the attachment.

Return Values

If the method succeeds, the return value is TRUE.

If the method fails, the return value is FALSE.

SetMessageAttachmentAsStream

(xe “SetMessageAttachmentAsStream”}

{xe “TESDK:SetMessageAttachmentAsStream”}

procedure SetMessageAttachmentAsStream(MID: String; Name: String; Value: TMemoryStream);

The SetMessageAttachmentAsStream attaches a file to a message from a stream. This method will attach and compress a file to a message based upon a stream.

For example,

MyESDK. SetMessageAttachmentAsStream(MID, “AUTOEXEC.BAT”,MyStream) Attachments are automatically compressed as they are included with the message. To attach a message from a file instead of memory, see SetMessageAttachmentAsFile. To extract a message upon receipt, use the GetMessageAttachmentAsFile method. Streams are designed primarily for Borland development environments. For Microsoft and other development environments see SetMessageAttachmentAsOleVariant instead. To clear all the attachments from a message, call the ClearMessageAttachments method.

Parameters

MID

A string representing the message identifier of the message.

Name

A string representing the path and filename of the attachment.

Value

A stream representing the attachment.

SetMessageAttachmentAsOleVariant

{xe “SetMessageAttachmentAsOleVariant”}

{xe “TESDK:SetMessageAttachmentAsOleVariant”}

procedure SetMessageAttachmentAsOleVariant (MID: String; Name: String; Value: OleVariant);

The SetMessageAttachmentAsOleVariant attaches a file to a message from an olevariant. This method will attach and compress a file to a message based upon an olevariant.

For example,

MyESDK.SetMessageAttachmentAsOleVariant(MID,“AUTOEXEC.BAT”, MyOleVariant)

Attachments are automatically compressed as they are included with the message. To attach a message from a file instead of memory, see SetMessageAttachmentAsFile. To extract a message upon receipt, use the GetMessageAttachmentAsFile method. OleVariants are designed primarily for Microsoft development environments. For Borland development environments see SetMessageAttachmentAsStream instead. To clear all the attachments from a message, call the ClearMessageAttachments method.

Parameters

MID

A string representing the message identifier of the message.

Name

A string representing the path and filename of the attachment.

Value

An olevariant representing the attachment.

GetMessageString

{xe “GetMessageString”}{xe “TESDK:GetMessageString”}

function GetMessageString(MID: String; Prop: Integer): String;

The GetMessageString method gets a property string from an in-memory message record. To retrieve a string from an in-memory message record, provide the MID of the message record and the property value of the string.

For example,

Identity=MyESDK. GetMessageString(MID, 103)

The property value 103 (T_MESSAGE_FROM) represents the sender's identity. For a complete listing of property values, see Message constants. To create extensible custom message properties, see How to Create a Custom Message Property.

Parameters

MID

A string representing the message identification value.

Prop

An integer representing the property value of the string.

Return Values

If the method succeeds, the return value is the string value of the specified property.

If the method fails, the return value is NULL.

GetMessageInteger

{xe “GetMessageInteger”}{xe “TESDK:GetMessageInteger”}

function GetMessageInteger(MID: String; Prop: Integer): Integer;

The GetMessageInteger method gets a property integer from an in-memory message record. To retrieve an integer from an in-memory message record, provide the MID of the message record and the property value of the integer. For a listing property values, see Message constants. To create extensible custom message properties, see How to Create a Custom Message Property.

Parameters

MID

A string representing the message identification value.

Prop

An integer representing the property value of the integer.

Return Values

If the method succeeds, the return value is the integer value of the specified property.

If the method fails, the return value is 0.

GetMessageBoolean

{xe “GetMessageBoolean”}{xe “TESDK:GetMessageBoolean”}

function GetMessageBoolean(MID: String; Prop: Integer): Boolean;

The GetMessageBoolean method gets a property boolean from an in-memory message record. To retrieve a boolean from an in-memory message record, provide the MID of the message record and the property value of the boolean. For a listing property values, see Message constants. To create extensible custom message properties, see How to Create a Custom Message Property.

Parameters

MID

A string representing the message identification value.

Prop

An integer representing the property value of the boolean.

Return Values

If the method succeeds, the return value is the boolean value of the specified property.

If the method fails, the return value is FALSE.

GetMessageDateTime

{xe “GetMessageDateTime”}{xe “TESDK:GetMessageDateTime”}

function GetMessageDateTime(MID: String; Prop: Integer): TDateTime;

The GetMessageDateTime method gets a property datetime from an in-memory message record. To retrieve a datetime from an in-memory message record, provide the MID of the message record and the property value of the datetime. For a listing property values, see Message constants. To create extensible custom message properties, see How to Create a Custom Message Property.

Parameters

MID

A string representing the message identification value.

Prop

An integer representing the property value of the datetime.

Return Values

If the method succeeds, the return value is the datetime value of the specified property.

If the method fails, the return value is 0.

GetMessageStream

{xe “GetMessageStream”}{xe “TESDK:GetMessageStream}

function GetMessageStream(MID: String; Prop: Integer): TMemoryStream;

The GetMessageStream method gets a property stream from an in-memory message record. To retrieve a stream from an in-memory message record, provide the MID of the message record and the property value of the stream. For a listing property values, see Message constants. To create extensible custom message properties, see How to Create a Custom Message Property.

Parameters

MID

A string representing the message identification value.

Prop

An integer representing the property value of the stream.

Return Values

If the method succeeds, the return value is the stream value of the specified property.

If the method fails, the return value is NIL.

GetMessageOleVariant

{xe “GetMessageOleVariant”}{xe “TESDK:GetMessageOleVariant”}

function GetMessageOleVariant(MID: String; Prop: Integer): OleVariant;

The GetMessageOleVariant method gets a property olevariant from an in-memory message record. To retrieve an olevariant from an in-memory message record, provide the MID of the message record and the property value of the olevariant. For a listing property values, see Message constants. To create extensible custom message properties, see How to Create a Custom Message Property.

Parameters

MID

A string representing the message identification value.

Prop

An integer representing the property value of the olevariant.

Return Values

If the method succeeds, the return value is the olevariant value of the specified property.

If the method fails, the return value is NIL.

GetMessageAttachmentName

{xe “GetMessageAttachmentName”}

{xe “TESDK:GetMessageAttachmentName”}

function GetMessageAttachmentName(MID: String; Index: Integer): String;

The GetMessageAttachmentName method returns the name associated with a given in-memory message attachment based upon the message attachment index. To determine the total count of attachments related to a message in memory, call the GetMessageAttachmentCount method. Indexes are relative to zero in memory. To walk the entire attachment list in memory, start at zero and go to GetMessageAttachmentCount minus one.

Parameters

MID

A string representing the message identification value.

Index

An integer representing the in-memory message index.

Return Values

If the method succeeds, the return value is a string representing the name of the attachment.

If the method fails, the return value is NULL.

GetMessageAttachmentCount

{xe “GetMessageAttachmentCount”}

{xe “TESDK:GetMessageAttachmentCount”}

function GetMessageAttachmentCount(MID: String): Integer

The GetMessageAttachmentCount method returns the total number of in-memory message attachments associated with the specified in-memory message. To extract the message attachment names associated with any particular index, see GetMessageAttachmentName.

Parameters

MID

A string representing the message identification value.

Return Values

If the method succeeds, the return value is an integer message attachment count.

If the method fails, the return value is 0.

GetMessageAttachmentAsFile

{xe “GetMessageAttachmentAsFile”}

{xe “TESDK:GetMessageAttachmentAsFile”}

function GetMessageAttachmentAsFile(MID: String; Index: Integer; Name: String) Boolean;

The GetMessageAttachmentAsFile method saves an in-memory message attachment to a file. To determine the total count of attachments in memory, call the GetMessageAttachmentCount method. Message attachment indexes are relative to zero in memory. To walk the entire message attachment listing in memory, start at zero and go to GetMessageAttachmentCount minus one.

Parameters

MID

A string representing the message identification value.

Index

An integer representing the in-memory message index.

Name

A string representing the path and filename of the saved attachment.

Return Values

If the method succeeds, the return value is TRUE.

If the method fails, the return value is FALSE.

GetMessageAttachmentAsStream

{xe “GetMessageAttachmentAsStream”}

{xe “TESDK:GetMessageAttachmentAsStream”}

function GetMessageAttachmentAsStream(MID: String; Index: Integer): TMemoryStream;

The GetMessageAttachmentAsStream method gets a stream from an in-memory message attachment. To determine the total count of attachments in memory, call the GetMessageAttachmentCount method. Message attachment indexes are relative to zero in memory. To walk the entire message attachment listing in memory, must start at zero and go to GetMessageAttachmentCount minus one.

Parameters

MID

A string representing the message identification value.

Index

An integer representing the in-memory message index.

Return Values

If the method succeeds, the return value is a stream.

If the method fails, the return value is NIL.

GetMessageAttachmentAsOleVariant

{xe “GetMessageAttachmentAsOleVariant”}

{xe “TESDK:GetMessageAttachmentAsOleVariant”}

function GetMessageAttachmentAsOleVariant(MID: String; Index: Integer): OleVariant;

The GetMessageAttachmentAsOleVariant method gets an olevariant from an in-memory message attachment. To determine the total count of attachments in memory, call the GetMessageAttachmentCount method. Message attachment indexes are relative to zero in memory. To walk the entire message attachment listing in memory, start at zero and go to GetMessageAttachmentCount minus one.

Parameters

MID

A string representing the message identification value.

Index

An integer representing the in-memory message index.

Return Values

If the method succeeds, the return value is an olevariant.

If the method fails, the return value is NIL.

GetMessageBodyAsText

{xe “GetMessageBodyAsText”}{xe “TESDK:GetMessageBodyAsText”}

function GetMessageBodyAsText(MID: String): String;

The GetMessageBodyAsText method gets the body of a message from an in-memory message record. The body is converted from an RTF format to plain text as it is extracted into a string.

For example,

Text=MyESDK.GetMessageBodyAsText(MID)

To extract the body of a message in Rich Text Format, see GetMessageBodyAsRTF instead.

Parameters

MID

A string representing the message identification value.

Return Values

If the method succeeds, the return value is a string representing the body of a message.

If the method fails, the return value is NULL.

GetMessageBodyAsRTF

{xe “GetMessageBodyAsRTF”}{xe “TESDK:GetMessageBodyAsRTF”}

function GetMessageBodyAsRTF(MID: String): String;

The GetMessageBodyAsRTF method gets the body of a message from an in-memory message record. The body is formatted in Rich Text Format as it is extracted into a string.

For example,

RTF=MyESDK.GetMessageBodyAsRTF(MID)

To extract the body of a message in plain text, see GetMessageBodyAsText instead.

Parameters

MID

A string representing the message identification value.

Return Values

If the method succeeds, the return value is a string representing the body of a message.

If the method fails, the return value is NULL.

GetMessageRecipientCount

{xe “GetMessageRecipientCount”}{“TESDK:GetMessageRecipientCount”}

function GetMessageRecipientCount(MID: String): Integer;

The GetMessageRecipientCount method returns the total number of in-memory recipients associated with the specified in-memory message. To extract the message recipient names associated with any particular index, see GetMessageRecipientName.

Parameters

MID

A string representing the message identification value.

Return Values

If the method succeeds, the return value is an integer message recipient count.

If the method fails, the return value is 0.

GetMessageRecipientName {xe “GetMessageRecipientName”}{xe “TESDK:GetMessageRecipientName”}

function GetMessageRecipientName(MID: String; Index: Integer): String;

The GetMessageRecipientName method returns the name associated with a given in-memory message recipient based upon the message recipient index. To determine the total count of recipients related to a message in memory, call the GetMessageRecipientCount method. Indexes are relative to zero in memory. To walk the entire recipient list in memory, start at zero and go to GetMessageRecipientCount minus one.

Parameters

MID

A string representing the message identification value.

Index

An integer representing the in-memory recipient index.

Return Values

If the method succeeds, the return value is a string representing the name of the recipient.

If the method fails, the return value is NULL.

GetMessageRecipientUserCount

{xe “GetMessageRecipientUserCount”}

{xe “TESDK:GetMessageRecipientUserCount”}

function GetMessageRecipientUserCount(MID: String; Index: Integer): Integer;

The GetMessageRecipientUserCount method returns the total number of in-memory user identifications associated with the specified in-memory message recipient. To extract the message recipient user identification associated with any particular index, see GetMessageRecipientUser.

Parameters

MID

A string representing the message identification value.

Index

An integer representing the in-memory recipient user identification index.

Return Values

If the method succeeds, the return value is an integer message recipient user identification count.

If the method fails, the return value is 0.

GetMessageRecipientUser

{xe “GetMessageRecipientUser”}{xe “TESDK:GetMessageRicipientUser”}

function GetMessageRecipientUser(MID: String; Index, IndexU; Integer) String;

The GetMessageRecipientUser method returns the user identification associated with a given in-memory message recipient based upon the message recipient user identification index. To determine the total count of recipient user identifications related to a message recipient in memory, call the GetMessageRecipientUserCount method. Indexes are relative to zero in memory. To walk the entire recipient list in memory, start at zero and go to GetMessageRecipientUserCount minus one.

Parameters

MID

A string representing the message identification value.

Index

An integer representing the in-memory recipient index.

IndexU

An integer representing the in-memory recipient user identification index.

Return Values

If the method succeeds, the return value is a string representing the user identification.

If the method fails, the return value is NULL.

GetMessageCount

{xe “GetMessageCount”}{xe “TESDK:GetMessageCount”}

function GetMessageCount: Integer;

The GetMessageCount method returns the total number of in-memory messages that have been received within the real-time client. The real-time client keeps track of messages in memory. Messages are automatically cleared from memory if MessageAutoClear is TRUE once the message is received and after the OnMessage event or the message is sent using SetMessage. To manually clear in-memory message records, see the ClearMessage and ClearMessageAll methods.

Return Values

If the method succeeds, the return value is an integer message count.

If the method fails, the return value is 0.

GetMessageMID

{xe “GetMessageMID”}{xe “TESDK:GetMessageMID”}

function GetMessageMID(Index: Integer): String;

The GetMessageMID method returns the MID associated with a given in-memory message based upon the in-memory message index. To determine the total count of messages in memory, call the GetMessageCount method. Message indexes are relative to zero in memory. To walk the entire status listing in memory, at zero and go to GetMessageCount minus one.

Parameters

Index

An integer representing the in-memory message index.

Return Values

If the method succeeds, the return value is the MID string.

If the method fails, the return value is NULL.

GetMessageRequestAll

{xe “GetMessageRequestAll”}{xe “TESDK:GetMessageRequestAll”}

function GetMessageRequestAll: Boolean;

The GetMessageRequestAll method requests all pending messages for the user from the real-time server. To obtain any offline or pending messages for the user from the real-time server use this method. The message is received in the OnMessage event.

Return Values

If the method succeeds, the return value is TRUE.

If the method fails, the return value is FALSE.

ExistMessageProp

{xe “ExistMessageProp”}{xe “TESDK:ExistMessageProp”}

function ExistMessageProp(MID: String; Prop: Integer): Boolean;

The ExistMessageProp method checks for the existence of a property within an in-memory message record. This method can be used to check for the existence of a property in an in-memory message record. The method can be used for both common message properties and custom message properties. For a listing property values, see Message constants. To create extensible custom message properties, see How to Create a Custom Message Property.

Parameters

MID

A string representing the message identification value.

Prop

An integer representing the property value.

Return Values

If the method succeeds, the return value is TRUE.

If the method fails, the return value is FALSE.

ExistMessage

{xe “ExistMessaGe”}{xe “TESDK:ExistMessage”}

function ExistMessage(MID: String): Boolean;

The ExistMessage method checks for the existence of a given in-memory message record.

Parameters

MID

A string representing the message identification value.

Return Values

If the method succeeds, the return value is TRUE.

If the method fails, the return value is FALSE.

ClearMessage

{xe “ClearMessape”}{xe “TESDK:ClearMessage”}

procedure ClearMessage(ID: String);

The ClearMessage method clears an in-memory message.

Parameters

MID

A string representing the message identification value.

ClearMessageAll

{xe “ClearMessageAll”}{xe “TESDK:ClearMessageAll”}

procedure ClearMessageAll;

The ClearMessageAll method clears all in-memory messages.

ClearMessageRecipients

{xe “ClearMessageRecipients”}{xe “TESDK:ClearMessageRecipients”}

procedure ClearMessageRecipients(MID: String);

The ClearMessageRecipients method clears the recipients from an in-memory message. This method can be used to clear the recipients from any in-memory message.

Parameters

MID

A string representing the message identification value.

ClearMessageAttachment

{xe “ClearMessageAttachments”}{xe “TESDK:ClearMessageAttachments”}

procedure ClearMessageAttachments(MID: String);

The ClearMessageRecipients method clears the attachments from an in-memory message. This method can be used to clear the attachments and free the associated memory from any in-memory message.

Parameters

MID

A string representing the message identification value.

Connect

{xe “Connect”}{xe “TESDK:Connect”}

function Connect:Boolean;

The Connect method attempts to connect to a real-time server. In order to connect to a real-time server, first provide the IP address and Port information of the real-time server along with the client's Identity and personal user identification UID. The Connect method returns TRUE if a socket connection was established. The Connect method returning TRUE does not constitute that the connection is approved by the real-time server. The connection is not approved until an OnClientConnected event is received.

For example,

MyESDK.IP=“127.0.0.1”

MyESDK. Port=35000

MyESDK.Identity=“John Smith”

MyESDK.UID MyESDKCreateID

MyESDK.Connect

For more details on connecting to a real-time server, see How To Connect to a Server.

Return Values

If the method succeeds, the return value is TRUE.

If the method fails, the return value is FALSE.

Disconnect

{xe “Disconnect”}{xe “TESDK:Disconnect”}

procedure Disconnect;

The Disconnect method attempts to disconnect from a real-time server. The Disconnect method issues a graceful disconnection from a real-time server. The Disconnect method automatically sets the user status to offline before the user is disconnected.

For example,

MyESDK.Disconnect

Events

OnClientError

{xe “OnClientError”}{xe “TESDK:OnClientError”}

property OnClientError: TOnClientError;

The OnClientError event is fired if the real-time client experiences an error in connection or communications. Typically this event is fired in the event of a socket communications problem. This event is optional.

Parameters

Error

A string representing the client error message.

OnClientConnectProgress

{xe “OnClientConnectProgress” “TESDK:OnClientConnectProgress”}

property OnClientConnectProgress: TOnClientConnectProgress;

The OnClientConnectProgress event provides information concerning the connection progress. This event is optional and can be used to inform users of the status of the connection progress.

Parameters

Msg

A string representing the client connection progress message.

OnClientConnected

{xe “OnClientConnected”}{Xe “TESDK:OnClientConnected”}

property OnClientConnected: TOnClientConnected;

The OnClientConnected event is fired when the connection is fully established and communication can proceed. This event should be handled by the real-time client application and all initial status and initial message delivery communications should happen in this event. During this event it is typical to set personal status, make requests for other user's status and request any messages that are offline or pending. The following examples demonstrate the appropriate methods.

For example,

MyESDK.SetStatusInteger(1 01,1)

MyESDK.SetStatusString(1 00,“Online

MyESDK.SetStatus

The above example sets the status message and icon to online. See SetStatus for more information.

For example,

MyESDK.GetStatusRequestAll

The above example requests an entire listing of users from the real-time server. See GetStatusRequestAll for more information.

For example,

MyESDK. GetMessageRequestAll

The above example requests all offline and stored messages from the real-time server. See GetMessageRequestAll for more information.

OnClientDisconnected

{xe “OnClientDisconnected”}{xe “TESDK:OnClientDisconnected”

property OnClientDisconnected: TOnClientDisconnected;

The OnClientDisconnected event is fired when the client disconnects from the real-time server. This event is optional and can be used to be informed of a disconnection.

OnClientCertificateKeys

{xe “OnClientCertificateKeys”}{xe “TESDK:OnClientCertificateKeys”}

property OnClientCertificateKeys: TOnClientCertificateKeys;

The OnClientCertificateKeys event is fired when the real-time server is using a security policy that requires public key encryption keys in order to communicate with the real-time server. This event is optional and can be handled by the real-time client application if the client maintains the public and private keys. The CreateKeys parameter should be set to TRUE if the keys will be created automatically and FALSE if the keys will be provided manually. Because keys can take some time to be generated, it is beneficial to retain the keys in the client application and pass them back through the use of this event. For more details on this topic see the GetSecurity and GetCertificateKeys methods.

Parameters

CreateKeys

A boolean indicating whether the certificate keys should be created automatically or manually.

PublicKey

A string representing the public key of an encryption key pair.

PrivateKey

A string representing the private key of an encryption key pair.

OnClientUID

{xe “OnClientUID”}{xe “TESDK:OnClientUID”}

property OnClientUID: TOnClientUID;

The OnClientUID event is fired when the real-time server is providing the correct user identification based upon the Account and Password provided during the connection sequence. This event should be handled by the real-time client application in the case of password authentication.

Parameters

UID

A string representing the user identification of an authenticated user.

OnClientLogon

{xe “OnClientLogon”}{“TESDK:OnClientLogon”}

property OnClientLogon: TOnClientLogon;

The OnClientLogon event is fired in the event the real-time server needs an Account and Password to proceed with the connection. This event should be handled by the real-time client application if using password authentication.

Parameters

Account

A string representing the account name for logon.

Password

A string representing the password for logon.

OnServerMessage

{xe “OnServerMessage”}{xe “TESDK:OnServerMessage”}

property OnServerMessage: TOnServerMessage;

The OnServerMessage event is fired when the real-time server needs to report a condition, message or error the real-time client. This event should be handled by the real-time client application and the message should be displayed to the real-time client user.

Parameters

Msg

A string representing the server message.

OnStatus

{xe “OnStatus”}{xe “TESDK:OnStatus”}

property OnStatus: TOnStatus;

The OnStatus event is fired when an incoming status is received. Status events can be caused by both manual requests, and automatic status requests. GetStatusRequestAll and GetStatusRequestQuery will cause manually status events based upon the requested status information. One status event is generated for each user that matches the requested query. The client will be automatically notified with an OnStatus event as a user's status changes provided, either use fall status mode or by individually requesting status tracking for specific UIDs by calling the GetStatusRequest method. To change from full state mode to partial status mode, see the SetStatusMode method.

Parameters

UID

A string representing the user identification value.

OnMessage

{xe “OnMessage”}{xe “TESDK:OnMessage”}

property OnMessage: TOnMessage;

The OnMessage event is fired when an incoming message is received. Message events can occur automatically while the client is connected to a real-time server. A message event can also occur manually through the use of the GetMessageRequestAll event. The optional delivered parameter allows the client to control the state of the delivery of the message. This information is logged by the Audit and Reporting add-ons for tracking purposes and can be used for a variety of purposes related to message delivery confirmation. The default value of 2 (T_DELIVERED) instructs the real-time server than the message was delivered. For more information on this subject, see How To: Receive a message.

Parameters

MID

A string representing the message identification value.

Delivered

A string representing the delivery value.

OnCommand

{xe “OnCommand”}{xe “TESDK:OnCommand”}

property OnCommand: TOnCommand;

The OnCommand event is fired when an incoming real-time command is received.

Parameters

RID

A string representing the command identification value.

How to Connect to a Server

The following describes the basics of connecting to a real-time server. The client must supply the IP address and Port information of the real-time server along with the client's Identity and personal user identification (UID) and then call the Connect method.

For example,

MyESDK.IP=“127.0.0.1”

MyESDK. Port=35000

MyESDK.Identity=“John Smith”

MyESDK.UID MyESDK.CreateID

MyESDK.Connect

UID

A UID uniquely identifies the user to the real-time server. The user can either maintain the UID information in the client application or the can enable authentication on the real-time server and have the real-time server maintain the UID information. If the user maintains the UID within the application, the client needs to call CreateID at least once to generate a UID value and then retain that value in the client application. If the real-time server is maintaining the UID, the client must enable user authentication in the real-time server console and provide an Account and Password when the client connects. Once the account and password are verified by the real-time server, the client will be provided the user's UID through the OnClientUID event.

Connection Related Events

OnClieintConnectProgress

The OnClientConnectProgress event provides information concerning the connection progress. This event is optional and can be used to inform users of the status of the connection progress.

OnClientConnected

The OnClientConnected event is fired when the connection is fully established and communication can proceed. This event should be handled by the real-time client application and all initial status and initial message delivery communications should happen in this event.

OnClientDisconnected

The OnClientDisconnected event is fired when the client disconnects from the real-time server. This event is optional and can be used to inform users of a disconnection.

OnClientLogon

The OnClientLogon event is fired in the event the real-time server needs an Account and Password to proceed with the connection. This event should be handled by the real-time client application if the user intends to use password authentication.

OnClientUID

The OnClientUID event is fired when the real-time server is providing the correct user identification based upon the Account and Password provided during the connection sequence. This event should be handled by the real-time client application if the user intends to use password authentication.

OnClientError

The OnClientError event is fired if the real-time client experiences an error in connection or communications. Typically this event is fired in the event of a socket communications problem. This event is optional.

OnServerMessage

The OnServerMessage event is fired when the real-time server needs to report a condition, message or error the real-time client. This event should be handled by the real-time client application and the message should be displayed to the real-time client user.

OnClientCertificateKeys

The OnClientCertificateKeys event is fired when the real-time server is using a security policy that requires public key encryption keys in order to communicate with the real-time server. This event is optional and can be handled by the real-time client application if the client maintains the public and private keys.

How to Send Status

The following describes the basics of sending personal status to the real-time server.

For example.

MyESDK.SetStatusInteger(101.1)

MyESDK.SetStatusString(100,“Online”)

MyESDK.SetStatus

In the above example the SetStatusInteger method sets the property 101 (T_STATUS_STI) to the value 1 (STA_ON). This sets the status icon to online. The SetStatusString method sets the property 100 (T_STATUS_MSG) to the value “Online”. This sets the message that is displayed for status.

The SetStatus method can be called at any time the client needs to update or change its personal status with the real-time server. After an initial connection is established it is normal to announce personal status to the real-time server during the OnClientConnected event. For a listing property values, see Status constants.

How to Send a Message

To send a message within the real-time client, construct a complete message with various details. Those details include setting the recipients, the sender, the subject and the body of a message and then calling SetMessage to send the message. For a listing property values, see Message constants.

For example,

MyESDK.SetMessageRecipient(MID,“John Smith”, UID)

MyESDK.SetMessageString(MID,103,“Myself”)

MyESDK.SetMessageString(MID,109,UID);

MyESDK.SetMessageDateTime(MID, 106, Now)

MyESDK.SetMessageString(MID, 105,“My Subject”)

MyESDK.SetMessageBodyAsRTF(MID, RTF)

MyESDK.SetMessage(MID)

Recipients

To add recipients to the message, see the SetMessageRecipient method, above. As many recipients as desired for a message may be designated by calling once for each given recipient.

For example,

MyESDK. SetMessageRecipient(MID,“John Smith”, UID)

In the above example, the UID represents the recipient John Smith's UID value. By calling SetMessageRecipient with the same name and different UIDs the client will create a single visible object within the recipient list that is sent to multiple UIDs.

Sender

To set the sender's information, use 103 (T_MESSAGE_FROM) and 109 (T_MESSAGE_FROM_UID) related message constants. For more information, see Message constants.

For example,

MyESDK.SetMessageString(MID, ‘Myself’)

MyESDK.SetMessageString(MI D, 109, UID);

Sent

To set the sent date and time, use 106 (T-MESSAGE_SENT) and the datetime that the message was sent.

For example,

MyESDK. SetMessageDateTime(MID, 106, Now)

Under Microsoft development environments use DateTime.Now.ToOADate to get the correctly formatted date and time.

Subject

To set the subject use 105 (T_MESSAGE_SUBJECT).

For example,

MyESDK. SetMessageString(MID, 1 05,“My Subject”)

Body

The body of a message is a rich text formatted content. To add body content to the message, use the SetMessageBodyAsRTF or the SetMessageBodyAsText methods.

For example,

MyESDK.SetMessageBodyAsRTF(MID, RTF)

Sending the Message

To send the message once it is constructed, call the SetMessage method.

For example,

MyESDK.SetMessage(MID)

Attachments

Attachments are optional and can be included with a message using the SetMessageAttachmentAsFile, SetMessageAttachmentAsStream and SetMessageAttachmentAsOleVariant methods.

Custom properties

Custom message properties allow the user to include unique information with any message sent. For more information on custom message properties, see How To Create a Custom Message Property.

How to Receive a Message

To receive messages, handle the OnMessage event within the real-time client. The OnMessage event is fired whenever a message is received. Message events can occur automatically while connected to a real-time server. A message event can also occur manually through the use of the GetMessageRequestAll event.

For example,

Identity=MyESDK.GetMessageString(MID, 103)

RichText.Rtf=MyESDK.GetMessageBodyAsRTF(MI D)

In the above example, the identity of the sender 103 (T_MESSAGE_FROM) is extracted from the incoming message and placed into the variable Identity. The MID is a parameter to the OnMessage event. The body of the message is then extracted from the message using the GetMessageBodyAsRTF method and placed directly into a RichEdit control visually residing on the form.

Within the OnMessage event, the optional delivered parameter allows the client to control the state of the delivery of the message. This information is logged by the Audit and Reporting add-ons for tracking purposes and can be used for a variety of purposes related to message delivery confirmation. The default value of 2 (T_DELIVERED) instructs the real-time server than the message was delivered.

Other delivery parameters include:

T_UNDELIVERED=1

The message is undelivered. The message will remain on the server and will be resent on the next message request;

T_DELIVERED=2

The message is delivered. The delivery is logged and the message is purged from the real-time server.

T_PERFORMED=3

Not used for messages.

T_DENIED=4

Not used for messages.

T_EXPIRED=5

The message expired instead of being delivered.

How to Receive Status

To receive status, handle the OnStatus event within the real-time client. The OnStatus event is fired when an incoming status is received.

For example,

Identity=MyESDK.GetStatusString(UID, 103)

State=MyESDK.GetStatusInteger(UID, 101)

In the above example, the identity 103 (T_STATUS_IDENTITY) is extracted from the incoming status and placed into the variable Identity. The state 101 (T_STATUS_STI) is then extracted from the incoming status and placed into the variable State. subsequently use this status information to populate a buddy list contained within a ListView or TreeView visual component.

Status events can be caused by both manual requests, and automatic status requests. GetStatusRequestAll and GetStatusRequestQuery will cause manually status events based upon the requested status information. One status event is generated for each user that matches the requested query. The client will be automatically notified with an OnStatus event as a user's status changes provided either use full status mode or by individually requesting status tracking for specific UIDs by calling the GetStatusRequest method. To change from full state mode to partial status mode, see the SetStatusMode method.

How to Create a Custom Status Property

The status properties within the ESDK are completely extensible. Using the SetStatusString, SetStatusInteger, SetStatusDateTime and SetStatusBoolean methods custom status properties can be applied to any status.

For example,

MyESDK.SetStatusInteger(1 0000,5)

MyESDK.SetStatusString(1 0001,“Data”)

MyESDK.SetStatus

In the above example the status property 10000 is assigned the integer value of 5 and the status property 10001 is assigned the string value “Data”. Starting any custom status properties at 10000 is recommended. It is important to remember and track the status property values within the application and the corresponding data type associated with the property. The information can be extracted using the respective GetStatusInteger and GetStatusString related methods.

How to Create a Custom Message Property

The message properties within the ESDK are completely extensible. Using the SetMessageString, SetMessageInteger, SetMessageBoolean, SetMessageDateTime and SetMessageStream methods, custom message properties can be applied to any message.

For example,

MyESDK.SetMessageInteger(MID, 10000,25)

MyESDK 10001,“Hello”)

MyESDK.SetMessage(MID)

In the above example the message property 10000 is assigned the integer value of 25 and the message property 11000 is assigned the string value “Hello”. Starting any custom message properties at 10000 is recommended. It is important to remember and track the message property values within the application and the corresponding data type associated with the property. The information can be extracted using the respective GetMessageInteger and GetMessageString related methods.

Constants

Status Constants

The following default status constants are predefined within the real-time client and server. To define custom status properties, see How To Create a Custom Status Property. To set any of the following status properties, see the SetStatusString, SetStatusInteger and SetStatusDateTime methods.

| | | Data | |
|---|---|---|---|
| Type | Value | Type | Description |
| T_STATUS_MSG | 100 | String | Status (“online”, |
| | | | “offline”, “away from |
| | | | desk”, etc) |
| T_STATUS_STI | 101 | Integer | State (1 = online 2 = off- |
| | | | line 3 = dnd, see below) |
| T_STATUS_IDENTITY_ | 103 | Identity | (ex: “John Smith”, the |
| | | | displayed name) |
| T_STATUS_LOGON | 104 | String | Network logon name |
| | | | (optional) |
| T_STATUS_MACH | 105 | String | Machine computer name |
| | | | (optional) |
| T_STATUS_PHONE | 106 | String | Phone number (optional) |
| T_STATUS_TIME | 110 | DateTime | Last status change date |
| | | | and time (optional) |
| T_STATUS_UID | 113 | String | UID |
| T_STATUS_GROUP | 115 | String | Member of group |
| | | | (optional) |
| T_STATUS_EMAIL | 121 | String | Email address (optional) |
| T_STATUS_IP | 122 | String | TCP/IP address |
| | | | (optional) |
| T_STATUS_VERSION | 123 | String | Version |

State Values

The following default state values are used in conjunction with the state integer property:

101 (T_STATUS_STI).

STA_NONE=0;

None.

| | | | |
|---|---|---|---|
| T_MESSAGE_PRIORITY_HIDE | 119 | Boolean | Always hide |
| | | | the message |
| T_MESSAGE_PRIORITY_SHOW | 124 | Boolean | Always show |
| | | | the message |
| T_MESSAGE_PRIORITY DEFAULT | 125 | Boolean | Always use |
| | | | preference |
| T_MESSAGE_POSITION | 126 | Boolean | Use custom |
| | | | position |
| T_MESSAGE_POSITION_UL | 127 | Integer | Upper left |
| T_MESSAGE_POSITION_UR | 128 | Integer | Upper right |
| T_MESSAGE_POSITION_LL | 129 | Integer | Lower left |
| T_MESSAGE_POSITION_LR | 130 | Integer | Lower right |
| T_MESSAGE_POSITION_ | 131 | Boolean | Always |
| CASCADE | | | cascade the |
| | | | message |
| T_MESSAGE_SIZE | 132 | Boolean | Use custom |
| | | | size |
| T_MESSAGE_SIZE_WIDTH | 133 | Integer | Width |
| T_MESSAGE_SIZE_HEIGHT | 134 | Integer | Height |

From the foregoing, it may be seen that the SDK of the present invention provides a set of tools for creating comprehensive real-time communication applications, such as instant messaging, chat and presence programs for business and other applications. The SDK is designed to operate in most newer development environments, such as those created by Borland and Microsoft.

The SDK of the present invention embeds instant messaging and presence within existing business software. The SDK also allows the customization of instant messaging (IM) solutions for business applications. The SDK also allows branded OEM products to utilize instant messaging of the present invention. The SDK of the present invention also allows real-time applications to stream information through the real-time engine. The SDK also provides web-based instant messaging solutions.

STA_ON=1;

The user is online.

STA_OFF=2;

The user is offline.

STA_DND=3;

The user is in the do not disturb state.

STA_AWAY=4

The user is in the away state.

Message Constants

The following default message constants are predefined within the real-time client and server. To define custom message properties, see How To Create a Custom Message Property. To set any of the following message properties, see the SetMessageString, SetMessageInteger and other related methods.

| Type | Value | Data Type | Description |
|---|---|---|---|
| T_MESSAGE_REPLY | 100 | Boolean | Reply is allowed |
| T_MESSAGE_MID | 101 | String | MID |
| T_MESSAGE_FROM | 103 | String | Identity of sender |
| | | | (displayed name) |
| T_MESSAGE_SUBJECT | 105 | String | Subject |
| T_MESSAGE_SENT | 106 | DateTime | Sent message |
| | | | date and time |
| T_MESSAGE_BUTTON | 107 | String | Instant reply |
| | | | button caption |
| T_MESSAGE_FROM_UID | 109 | String | UID of sender |

The real-time platform provides advanced features, such as comprehensive security and encryption, off-line message delivery, file attachments, auditing features, and archiving and the ability to extend any portion of the real-time architecture to transport custom information. The real-time platform has the ability to automatically interconnect multiple real-time servers together. The transport handles all the routing automatically, as disclosed herein, so interfacing software code to presence and instant messaging is less difficult to build and maintain, but is versatile enough to accomplish any real-time requirement needs.

The SDK, also referred to as ESDK, is completely extensible so that users can add information to status and presence or messages, as well as build entirely unique solutions, as required. Software programmers can leverage the off-line delivery capability of messages to include solution specific content.

The real-time transport technology, as disclosed herein, securely and efficiently connects multiple offices together and may route securely over virtually any TCP connection. The software programmer does not need to worry about how to communicate in real-time to a variety of people that are dispersed geographically, since this is handled automatically with the ESDK, as disclosed herein. Users are tracked throughout the real-time system based upon ESDK server. Real-time channel communications are automatically routed to the destination clients over any routed connection to constantly, persisted connections. All status information is automatically propagated throughout the real-time system over pipes and persistent client connections. A centralized management console allows the user to manage the connections between servers, security, routing, users and multiple groups.

What is claimed is:

1. A software development kit for enabling a developer to provide real-time communications capabilities to an application program, which comprises:
means for establishing a connection to a real-time server;
means for sending a message; and,
means for receiving a message.

2. The software development kit as claimed in claim 1, including:
means for disconnecting from a real-time server.

3. The software development kit as claimed in claim 1, including:
means for creating a communications channel through a real-time platform associated with said real-time server.

4. The software development kit as claimed in claim 3, including:
means for joining a third party user to said communications channel.

5. The software development kit as claimed in claim 3, including:
means for deleting a third party user from said communications channel.

6. The software development kit as claimed in claim 3, including:
means for invoking said communications channel.

7. The software development kit as claimed in claim 3, including:
means for destroying said communications channel.

8. The software development kit as claimed in claim 1, including:
means for announcing status to said real-time server.

9. The software development kit as claimed in claim 1, including:
means for requesting third party user status from said real-time server.
